(19) United States
(12) Patent Application Publication
(10) Pub. No.: US 2023/0099395 A1
(43) Pub. Date: Mar. 30, 2023

(54) INFORMATION PROCESSING DEVICE, SYSTEM, METHOD OF OPERATING SYSTEM, STORAGE MEDIUM, AND VEHICLE

(71) Applicant: TOYOTA JIDOSHA KABUSHIKI KAISHA, Toyota-shi (JP)

(72) Inventor: Makoto MATSUSHITA, Ichinomiya-shi (JP)

(73) Assignee: TOYOTA JIDOSHA KABUSHIKI KAISHA, Toyota-shi (JP)

(21) Appl. No.: 17/885,934

(22) Filed: Aug. 11, 2022

(30) Foreign Application Priority Data
Sep. 30, 2021 (JP) 2021-162186

(51) Int. Cl. G08G 1/01; H04B 5/00

(52) U.S. Cl. CPC G08G 1/0141; H04B 5/0031

(57) ABSTRACT

An information processing device has a communication unit that carries out near field communication, and a control unit that transmits and receives information through the communication unit. The control unit distributes traffic jam occurrence information including positional information indicating a position of a vehicle mounted with the information processing device, through the communication unit, when a moving speed of the vehicle is equal to a predetermined speed. The traffic jam occurrence information is further distributed by a different information processing device that is mounted in a different vehicle and that receives the traffic jam occurrence information.

### CROSS-REFERENCE TO RELATED APPLICATION

This application claims priority to Japanese Patent Application No. 2021-162186 filed on Sep. 30, 2021, incorporated herein by reference in its entirety.

### BACKGROUND

### 1. Technical Field

The present disclosure relates to an information processing device, a system, a method of operating the system, a storage medium, and a vehicle.

### 2. Description of Related Art

There is proposed an art contributing to the convenience of passengers by ensuring that a plurality of vehicles share information on a traffic jam in road communication. For example, Japanese Unexamined Patent Application Publication No. 2019-179298 (JP 2019-179298 A) discloses a system configured such that a photographed image of a traffic jam state is transmitted from a certain vehicle to an information processing device and this information processing device provides information on the traffic jam to another vehicle.

### SUMMARY

There is room for improvement in the efficiency of sharing information on a traffic jam among a plurality of vehicles.

The present disclosure provides an information processing device and the like that allow a plurality of vehicles to share information on a traffic jam.

An information processing device according to one aspect of the present disclosure is an information processing device having a communication unit that carries out near field communication, and a control unit that transmits and receives information through the communication unit. The control unit distributes traffic jam occurrence information including positional information indicating a position of a vehicle mounted with the information processing device, through the communication unit, when a moving speed of the vehicle is equal to a predetermined speed. The traffic jam occurrence information is further distributed by a different information processing device that is mounted in a different vehicle and that receives the traffic jam occurrence information.

An information processing device according to another aspect of the present disclosure is an information processing device having a communication unit that carries out near field communication, and a control unit that transmits and receives information through the communication unit. The control unit distributes, with the information processing device mounted in a vehicle, traffic jam occurrence information that is distributed by another information processing device mounted in a different vehicle when a moving speed of the different vehicle is equal to a predetermined speed and that includes positional information indicating a position of the different vehicle, through the communication unit, upon receiving the traffic jam occurrence information.

A method of operating a system according to the present disclosure is a method of operating a system having a plurality of information processing devices that carry out near field communication. The method includes a step in which the first information processing device distributes traffic jam occurrence information including positional information indicating a position of a vehicle mounted with the first information processing device when a moving speed of the vehicle is equal to a predetermined speed, and a step in which the second information processing device that is mounted in a different vehicle receives the traffic jam occurrence information, distributes the traffic jam occurrence information on condition that the different vehicle be located within a reference distance from the vehicle, and stops distributing the traffic jam occurrence information when the vehicle is not located within the reference distance from the different vehicle.

The information processing device and the like according to the present disclosure enable a plurality of vehicles to efficiently share information on a traffic jam.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view showing a configuration example of a system;

FIG. 2 is a view showing an operation example of the system; and

FIG. 3 is a flowchart showing an operation example of an information processing device.

### DETAILED DESCRIPTION OF EMBODIMENTS

The embodiments will be described later.

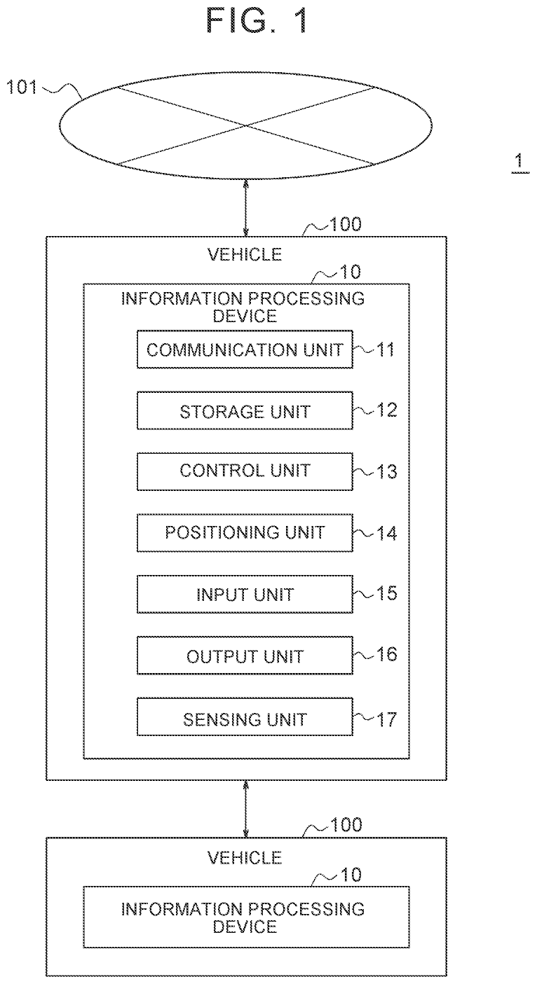

FIG. 1 is a view showing a configuration example of a system 1 according to one of the embodiments. The system 1 has a plurality of vehicles 100. Each of the vehicles 100 is mounted with an information processing device 10 having the function of wireless communication. Each of the vehicles 100 is, for example, a passenger vehicle such as a gasoline vehicle, a battery electric vehicle (BEV), a hybrid electric vehicle (HEV), a plug-in hybrid electric vehicle (PHEV), or a fuel cell electric vehicle (FCEV). Each of the vehicles 100 may be driven by a driver, or may be automatically driven at a certain level (e.g., at any one of levels 1 to 5 of Society of Automotive Engineers (SAE)). The information processing device 10 is an information processing device having the function of wireless communication, and is, for example, an in-vehicle device such as a car navigation device. The information processing device 10 has the function of communication that enables mobile communication and near field communication. The information processing device 10 can be connected to a public communication network 101 in a wireless manner, or can communicate with other information processing devices 10 in a wireless manner without the intermediary of the public communication network 101. The public communication network 101 is, for example, the Internet.

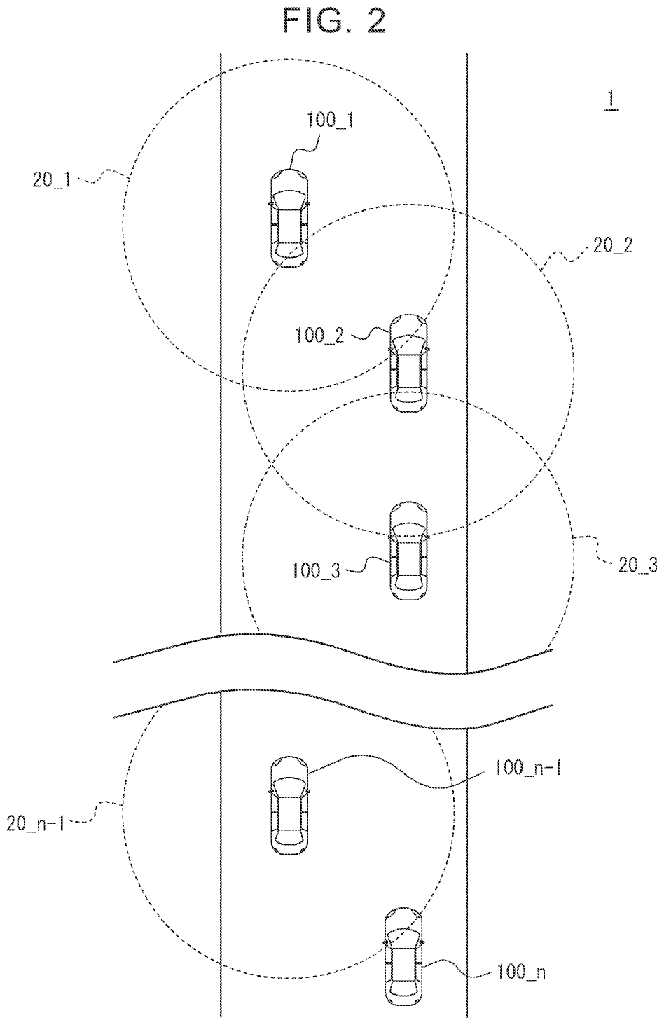

FIG. 2 is a view illustrating the outline of the operation of the system 1 according to the present embodiment. In the following description, each of the vehicles 100 will be referred to as a vehicle 100_n (n is a natural number), and will be referred to as the vehicle 100 in the collective sense of the term. The information processing device 10 with which each of the vehicles 100_n is mounted is omitted in the drawings.

In the system 1, when the moving speed of the vehicle 100_1 is equal to a predetermined speed, the information processing device 10 of the vehicle 100_1 distributes traffic jam occurrence information including positional information indicating a position of the vehicle 100_1 through near field communication. The predetermined speed is a low speed including 0 km/h, which indicates the likelihood of the occurrence of a traffic jam. The information processing device 10 of the following vehicle 100_2 located within a range 20_1 of near field communication from the vehicle 100_1 receives the traffic jam occurrence information, and distributes the traffic jam occurrence information on condition that the vehicle 100_2 be located within a reference distance from the vehicle 100_1. Then, the information processing device 10 of the following vehicle 100_3 located within a range 20_2 of near field communication from the vehicle 100_2 receives the traffic jam occurrence information. By the same token, the traffic jam occurrence information is sequentially conveyed to the following vehicles through near field communication. Then, the information processing device 10 of the following vehicle 100_n located within a range 20_n−1 of near field communication from the vehicle 100_n−1 receives the traffic jam occurrence information, and stops distributing the traffic jam occurrence information when the vehicle 100_n is not located within a reference distance from the vehicle 100_1. It should be noted herein that the reference distance is a distance that is arbitrarily set in advance within a range of, for example, several hundred meters to several kilometers, in such a manner as to correspond to an influential range of the traffic jam. In this manner, the traffic jam occurrence information distributed by the vehicle 100_1 is conveyed to the vehicle 100_n via near field communication.

When a traffic jam occurs, the influential range of the traffic jam is confined to a relatively narrow range. In the case where a server or the like that is in charge of collecting information on a range wider than the influential range accumulates the traffic jam occurrence information and then distributes this information to the respective vehicles 100, the lack of efficiency such as a temporal delay resulting from the accumulation of information in the server or wasteful distribution of the traffic jam occurrence information to the vehicles 100 outside the influential range may be caused. In the system 1, the information processing devices 10 of the respective vehicles 100 convey the traffic jam occurrence information to one another through near field communication, and hence can convey the information more rapidly than in the case where the information is accumulated in the server. Besides, the information processing devices 10 have the function of near field communication such as Wi-Fi (®) as a standard feature. Thus, vehicle-to-vehicle communication can be established with a simple configuration. Furthermore, as soon as the traffic jam occurrence information is conveyed from the first vehicle 100_1 in line that is closest to the cause of the traffic jam and hence generates the traffic jam occurrence information to the first vehicle 100_n outside a reference distance range, the distribution of the information is stopped. Therefore, the lack of efficiency such as wasteful distribution of the traffic jam occurrence information to an area outside the influential range of the traffic jam can be avoided. In consequence, the vehicles 100 can efficiently share the information on the traffic jam.

Returning to FIG. 1, the configuration of the information processing device 10 will be described. The information processing device 10 has a communication unit 11, a storage unit 12, a control unit 13, an input unit 15, an output unit 16, and a sensing unit 17.

The communication unit 11 includes at least one communication interface. The communication interface includes an interface corresponding to a mobile communication standard such as long term evolution (LTE), 4th Generation (4G), or 5th Generation (5G). Besides, the communication interface includes, for example, a near field communication interface corresponding to Wi-Fi, Bluetooth (®), or the like. The communication unit 11 receives information used to operate the control unit 13 from the outside, and transmits information obtained through operation of the control unit 13 to the outside. The communication unit 11 is connected to various in-vehicle instruments through near field communication, and is connected to the network 101 via a base station for mobile communication to function as an in-vehicle router. Besides, by being controlled by the control unit 13, the communication unit 11 distributes information through near field communication.

The storage unit 12 includes, for example, a main storage device, an auxiliary storage device, at least one semiconductor memory functioning as a cash memory, at least one magnetic memory, at least one optical memory, or a combination of at least two thereof. The semiconductor memory is, for example, a random access memory (RAM) or a read-only memory (ROM). The RAM is, for example, a static RAM (SRAM) or a dynamic RAM (DRAM). The ROM is, for example, an electrically erasable programmable ROM (EEPROM). The storage unit 12 stores information used to operate the information processing device 10, and information obtained through operation of the information processing device 10.

The control unit 13 includes at least one processor, at least one dedicated circuit, or a combination thereof. The processor is, for example, a general-purpose processor such as a central processing unit (CPU), or a dedicated processor specialized for a specific process such as a graphic processing unit (GPU). The dedicated circuit is, for example, a field-programmable gate array (FPGA), or an application specific integrated circuit (ASIC). The control unit 13 performs information processing regarding the operation of the information processing device 10 while controlling the respective units of the information processing device 10.

The functions of the information processing device 10 are realized through execution of a control program by the processor included in the control unit 13. The control program is a program for causing a computer to function as the information processing device 10. Besides, one, some or all of the functions of the information processing device 10 may be realized by the dedicated circuit included in the control unit 13. Besides, the control program may be stored in a non-transitory recording and storage medium that can be read by the information processing device 10, and may be read from the medium by the information processing device 10.

The positioning unit 14 includes a global navigation satellite system (GNSS) receiver. The GNSS includes, for example, at least one of a global positioning system (GPS), a quasi-zenith satellite system (QZSS), a BeiDou, a global navigation satellite system (GLONASS), and a Galileo. The positioning unit 34 acquires positional information on the information processing device 10, namely, positional information on the vehicle 100.

The input unit 15 includes at least one input interface. The input interface is, for example, a physical key, a capacitance key, a pointing device, a touch screen provided integrally with a display, or a microphone accepting acoustic inputs. The input unit 15 accepts the action of inputting information used to operate the information processing device 10, and transmits the input information to the control unit 13.

The output unit 16 includes at least one output interface. The output interface is, for example, a display or a speaker. The display is, for example, a liquid crystal display (LCD) or an organic electro-luminescence (EL) display. The output unit 16 outputs information obtained through operation of the information processing device 10.

The sensing unit 17 has at least one sensor group or an interface with the sensor group, and transmits information indicating a result sensed by the sensor group or the like to the control unit 13. The sensor group may be provided in the information processing device 10, or may be provided in the vehicle 100 and connected to the sensing unit 17 via an in-vehicle network complying with a standard such as the controlled area network (CAN). The sensor group includes a speed sensor that senses a moving speed of the vehicle 100. Furthermore, the sensor group includes a radar that senses whether or not there is a foreign object around the vehicle 100 and a distance to the object or the like, an image sensor that photographs the periphery of the vehicle 100, and the like. The sensing unit 17 transmits various sensed results, photographed images, and the like to the control unit 13, and the control unit 13 processes these pieces of information.

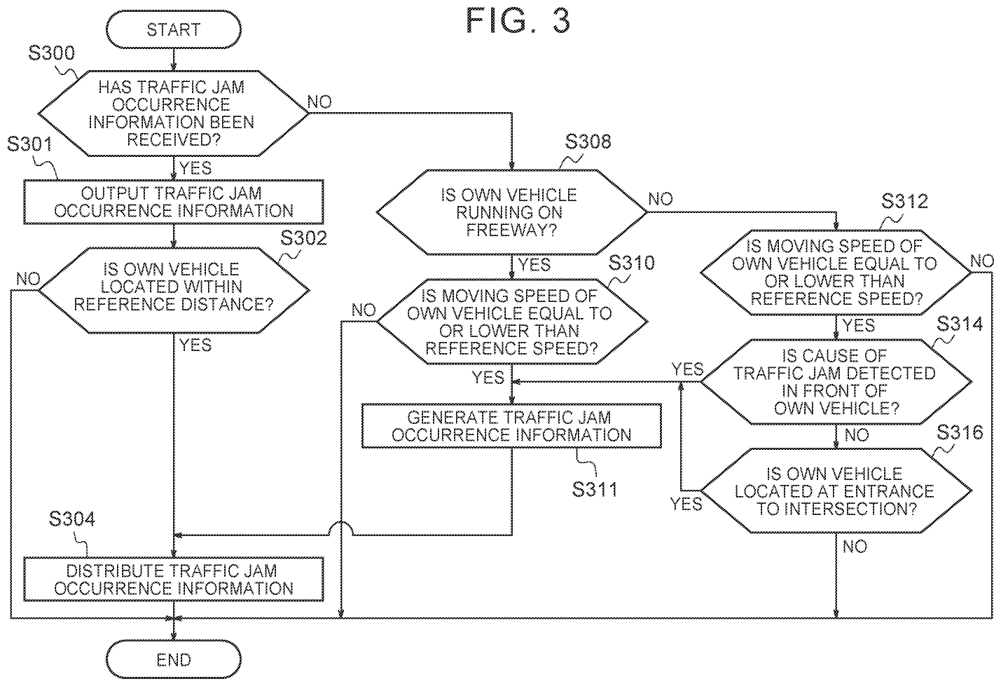

FIG. 3 is a flowchart illustrating an example of an operation procedure of the information processing device 10. The procedure of FIG. 3 is carried out by the control unit 13 on a certain cycle, for example, at intervals of several milliseconds to several seconds. The vehicle 100 mounted with the information processing device 10 that carries out the procedure of FIG. 3 will be referred to hereinafter as an own vehicle 100.

In step S300, the control unit 13 determines whether or not traffic jam occurrence information has been received from a different information processing device 10 mounted in a different vehicle 100. If traffic jam occurrence information has been received (Yes), the control unit 13 proceeds to step S301. If no traffic jam occurrence information has been received (No), the control unit 13 proceeds to step S308.

In step S301, the control unit 13 outputs traffic jam occurrence information. The output unit 16 displays or acoustically outputs a message providing information on the occurrence of a traffic jam and a distance to the first vehicle 100 in line, for example, a message indicating that “there is a traffic jam starting ahead at a distance of 2 km”. The control unit 13 calculates a distance to the first vehicle 100 in line based on positional information on the first vehicle 100 in line included in the traffic jam occurrence information and positional information on the own vehicle 100, and generates a message to be output. Thus, a passenger of the own vehicle 100 can recognize the occurrence of the traffic jam.

In step S302, the control unit 13 determines whether or not the own vehicle 100 is located within a reference distance from the first vehicle 100 in line. The traffic jam occurrence information includes positional information indicating the position of the first vehicle 100 in line. Information indicating the reference distance is stored in advance in the storage unit 12 of each of the information processing devices 10, and is read out from the storage unit 12 by the control unit 13. The control unit 13 determines whether or not the own vehicle 100 is located within the reference distance from the first vehicle 100 in line, based on the information on the reference distance and the positional information on the own vehicle 100 acquired from the positioning unit 14. If the own vehicle 100 is located within the reference distance (Yes), the control unit 13 proceeds to step S304.

In step S304, the control unit 13 distributes the traffic jam occurrence information through near field communication. The communication unit 11 distributes the traffic jam occurrence information through the use of a near field communication interface. For example, the traffic jam occurrence information is broadcast through an interface corresponding to Wi-Fi. For example, in the case where the communication unit 11 functions as an in-vehicle router of an in-vehicle instrument, the control unit 13 temporarily stops the communication unit 11 from functioning as the in-vehicle router, and distributes the traffic jam occurrence information.

After step S304, one processing cycle is ended. In this manner, the information processing device 10 conveys the traffic jam occurrence information distributed from the information processing device 10 of the different vehicle 100 to another different vehicle 100.

On the other hand, if the own vehicle 100 is not located within the reference distance from the position of the first vehicle 100 in line (No in step S302), the control unit 13 ends the present processing cycle. That is, the control unit 13 stops distributing the traffic jam occurrence information. In this manner, further wasteful distribution of the traffic jam occurrence information to an area beyond the reference distance is avoided.

If no traffic jam occurrence information has been received from the different information processing device 10 in step S300 (No), the control unit 13 determines in step S308 whether or not the own vehicle 100 is running on a freeway. The control unit 13 determines whether or not the own vehicle 100 is currently located on a freeway, through the use of map information stored in advance in the storage unit 12 and the positional information on the own vehicle 100. If the own vehicle 100 is located on a freeway (Yes), the control unit 13 proceeds to step S310. If the own vehicle 100 is not located on a freeway (No), the control unit 13 proceeds to step S312.

In step S310, the control unit 13 determines whether or not the moving speed of the own vehicle 100 is equal to or lower than a reference speed. In this case, for example, a speed equal to or lower than the reference speed corresponds to “the predetermined speed”. The reference speed is a speed at which the vehicle 100 is likely to be moving at a crawl as a result of a traffic jam when the moving speed of the vehicle 100 is equal to or lower than the reference speed on a freeway, for example, any speed from 0 km/h to 10 km/h. Information on the reference speed is stored in advance in the storage unit 12, and is read out from the storage unit 12 by the control unit 13. The control unit 13 acquires the moving speed of the own vehicle 100 from the sensing unit 17, and compares the acquired moving speed with the reference speed. If the moving speed is equal to or lower than the reference speed (Yes), there is likely to be a cause of a traffic jam in front of the vehicle 100. The cause of the traffic jam on a freeway is, for example, the blocking of a lane resulting from an accident, a construction work, or the like, the congestion resulting from the merging of lanes, or the congestion at a tollbooth. In this case, the control unit 13 proceeds to step S311. On the other hand, if the moving speed is not equal to or lower than the reference speed (No), the control unit 13 ends the present processing cycle.

In step S311, the control unit 13 generates traffic jam occurrence information. In this case, a process to be performed by the information processing device 10 mounted in the first vehicle 100 in line is performed. The control unit 13 generates traffic jam occurrence information that includes positional information on the own vehicle 100 acquired by the positioning unit 14 and that indicates the occurrence of a traffic jam. Then in step S304, the control unit 13 distributes the traffic jam occurrence information.

If it is determined in step S308 that the own vehicle 100 is not running on a freeway (No), the control unit 13 determines in step S312 whether or not the speed of the own vehicle 100 is equal to or lower than the reference speed. The reference speed mentioned herein is a speed at which the vehicle 100 is likely to be moving at a crawl as a result of a traffic jam when the moving speed of the vehicle 100 is equal to or lower than the reference speed on a road other than a freeway, namely, on a general road in a downtown area or the like, for example, any speed from 0 km/h to 5 km/h. Information on the reference speed is stored in advance in the storage unit 12, and is read out from the storage unit 12 by the control unit 13. If the moving speed is equal to or lower than the reference speed (Yes), there is more or less likely to be a cause of a traffic jam in front of the vehicle 100. The cause of the traffic jam is, for example, the blocking of a lane resulting from an accident, a construction work, or the like, or waiting at a stoplight at an intersection. In this case, the control unit 13 proceeds to step S314. On the other hand, if the moving speed is not equal to or lower than the reference speed (No), the control unit 13 ends the present processing cycle.

In step S314, the control unit 13 determines whether or not a cause of a traffic jam is detected in front of the own vehicle 100. The cause of the traffic jam mentioned herein is an obstacle such as a vehicle in an accident, a construction site, a fallen object, or the like. The control unit 13 detects the cause of the traffic jam from a result sensed by the sensing unit 17, a photographed image, or the like. For example, the control unit 13 detects whether or not there is an object in front of the own vehicle 100 and detects the size of the object from a result sensed by a radar, and then determines whether or not the object is an obstacle. Besides, the control unit 13 subjects the photographed image of an area in front of the own vehicle 100 to image recognition processing, and determines whether or not there is a vehicle in an accident, a construction site, a fallen object, or the like. At this time, the control unit 13 confirms whether or not there is a cause of the accident within a set distance that is arbitrarily set in front of the own vehicle 100. The set distance is, for example, a certain distance from several meters to several tens of meters. If a cause of an accident is detected (Yes), there is likely to be a cause of the traffic jam in front of the vehicle 100, so the control unit 13 proceeds to step S311 to generate traffic jam occurrence information. The control unit 13 then distributes the traffic jam occurrence information in step S304, and ends the present processing cycle. On the other hand, if a cause of an accident is not detected (No), the control unit 13 proceeds to step S316.

In step S316, the control unit 13 determines whether or not the own vehicle 100 is located at the entrance to an intersection. The control unit 13 determines whether or not the own vehicle 100 is currently located at the entrance to an intersection, through the use of map information stored in advance in the storage unit 12, and information on the current position of the own vehicle 100 acquired by the positioning unit 14. The entrance to an intersection is located within, for example, a set distance that is arbitrarily set from an end portion of the intersection. The set distance is, for example, several meters. If the own vehicle 100 is located at the entrance to an intersection (Yes), the vehicle 100 is likely to be stopped short of the intersection due to a red stoplight or the like, so the control unit 13 proceeds to step S311 to generate traffic jam occurrence information. The control unit 13 then distributes the traffic jam occurrence information in step S304, and ends the present processing cycle. On the other hand, if the own vehicle 100 is not located at the entrance to an intersection (No), the vehicle 100 is likely to be moving at a crawl for a reason other than the occurrence of a traffic jam, so the control unit 13 ends the present processing cycle.

In the foregoing procedure, the information processing device 10 can more accurately make a determination on the occurrence of a traffic jam, by determining whether or not a traffic jam has occurred based on a condition that differs depending on whether the own vehicle 100 is running on a freeway or on a general road. Besides, the information processing device 10 can more accurately make a determination on the occurrence of a traffic jam, by determining whether or not there is a cause of the traffic jam and whether or not the own vehicle 100 is located at an intersection while the own vehicle 100 is running on a general road. Incidentally, one of the conditions indicating whether or not there is a cause of a traffic jam and whether or not the own vehicle 100 is located at an intersection may be omitted as appropriate.

According to the present embodiment, the information processing devices 10 of the respective vehicles 100 convey traffic jam occurrence information to one another through near field communication, and hence can convey information more rapidly than in the case where this information is accumulated in a server. Besides, vehicle-to-vehicle communication can be established with a simple configuration. Furthermore, the lack of efficiency such as wasteful distribution of traffic jam occurrence information to the outside of an influential range of a traffic jam can be avoided. In consequence, the vehicles 100 can efficiently share information on the traffic jam.

In the foregoing description, at least one of the information processing devices 10 may be a smart phone, a tablet terminal or the like carried by a passenger of each of the vehicles 100. In this case, for example, each of the information processing devices 10 may be configured by making the smartphone, the tablet terminal or the like operate in coordination with the respective instruments of each of the vehicles 100 via an in-vehicle network that complies with a standard such as the controller are network (CAN).

It should be noted in the foregoing that those skilled in the art find it easy to carry out various modifications and corrections based on the present disclosure, although the present disclosure has been described based on the drawings and the embodiments. Accordingly, it should be noted that these modifications and corrections fall within the scope of the present disclosure. For example, the functions and the like included in the respective means, the respective steps and the like can be rearranged such that no logical contradiction is caused. The means, the steps and the like can be combined into one or divided.

What is claimed is:

1. An information processing device comprising:
a communication unit that carries out near field communication; and
a control unit that transmits and receives information through the communication unit, wherein
the control unit distributes traffic jam occurrence information including positional information indicating a position of a vehicle mounted with the information processing device, through the communication unit, when a moving speed of the vehicle is equal to a predetermined speed, and
the traffic jam occurrence information is further distributed by a different information processing device that is mounted in a different vehicle and that receives the traffic jam occurrence information.

2. The information processing device according to claim 1, wherein
the control unit further distributes the traffic jam occurrence information on condition that the vehicle be running on a predetermined road.

3. The information processing device according to claim 1, wherein
the control unit further distributes the traffic jam occurrence information on condition that a predetermined object be detected within a reference distance in front of the vehicle.

4. The information processing device according to claim 1, wherein
the control unit further distributes the traffic jam occurrence information on condition that the vehicle be located near an intersection.

5. The information processing device according to claim 1, wherein
the communication unit is configured to be able to communicate with a different device mounted in the vehicle via near field communication, connect to a public communication network, and relay the different device to the public communication network.

6. The information processing device according to claim 5, wherein
the traffic jam occurrence information is distributed from the communication unit without intermediary of the public communication network.

7. An information processing device comprising:
a communication unit that carries out near field communication; and
a control unit that transmits and receives information through the communication unit, wherein
the control unit distributes, with the information processing device mounted in a vehicle, traffic jam occurrence information that is distributed by another information processing device mounted in a different vehicle when a moving speed of the different vehicle is equal to a predetermined speed and that includes positional information indicating a position of the different vehicle, through the communication unit, upon receiving the traffic jam occurrence information.

8. The information processing device according to claim 7, wherein
the control unit distributes the traffic jam occurrence information on condition that the vehicle be located within a reference distance from the different vehicle, and stops distributing the traffic jam occurrence information when the vehicle is not located within the reference distance from the different vehicle.

9. The information processing device according to claim 7, wherein
the communication unit is configured to be able to communicate with a different device mounted in the vehicle through near field communication, connect to a public communication network, and relay the different device to the public communication network.

10. The information processing device according to claim 9, wherein
the traffic jam occurrence information is distributed from the communication unit without intermediary of the public communication network.

11. A method of operating a system having a plurality of information processing devices that carry out near field communication, the method comprising:
a step in which the first information processing device distributes traffic jam occurrence information including positional information indicating a position of a vehicle mounted with the first information processing device when a moving speed of the vehicle is equal to a predetermined speed; and
a step in which the second information processing device that is mounted in a different vehicle receives the traffic jam occurrence information, distributes the traffic jam occurrence information on condition that the different vehicle be located within a reference distance from the vehicle, and stops distributing the traffic jam occurrence information when the vehicle is not located within the reference distance from the different vehicle.

12. The method according to claim 11, wherein
the first information processing device further distributes the traffic jam occurrence information on condition that the vehicle be running on a predetermined road.

13. The method according to claim 11, wherein
each of the information processing devices further distributes the traffic jam occurrence information on condition that a predetermined object be detected within a predetermined distance in front of the vehicle.

14. The method according to claim 11, wherein
the first information processing device further distributes the traffic jam occurrence information on condition that the vehicle be located near an intersection.

15. The method according to claim 11, wherein
the first information processing device communicates with a different device mounted in the vehicle through near field communication, connects to a public communication network, and relays the different device to the public communication network.

16. The method according to claim 11, wherein
the second information processing device communicates with a different device mounted in the different vehicle through near field communication, connects to a public communication network, and relays the different device to the public communication network.

17. The method according to claim 16, wherein
the traffic jam occurrence information is distributed by the first information processing device or the second information processing device without intermediary of the public communication network.

18. A non-transitory storage medium that stores a program that is executed by an information processing device capable of carrying out near field communication to cause the information processing device to operate as the information processing device according to claim 1.

19. A non-transitory storage medium that stores a program that is executed by an information processing device capable of carrying out near field communication to cause the information processing device to operate as the information processing device according to claim 7.

20. A vehicle that is mounted with the information processing device according to claim 1.
